(19) United States
(12) Patent Application Publication
(10) Pub. No.: US 2015/0172904 A1
(43) Pub. Date: Jun. 18, 2015

(54) METHOD AND APPARATUS FOR OBTAINING INFORMATION ON CLIENT COOPERATION IN WIRELESS COMMUNICATION SYSTEM

(71) Applicant: LG ELECTRONICS INC., Seoul (KR)

(72) Inventors: Heejeong Cho, Seoul (KR); Eunjong Lee, Seoul (KR); Jaehoon Chung, Seoul (KR)

(21) Appl. No.: 14/416,577

(22) PCT Filed: Aug. 16, 2013
(86) PCT No.: PCT/KR2013/007405

§ 371 Date: Jan. 22, 2015

Related U.S. Application Data
(60) Provisional application No. 61/691,812, filed on Aug. 22, 2012.

(51) Int. Cl. H04W 8/00; H04W 72/04; H04B 7/02

(52) U.S. Cl. CPC H04W 8/005; H04B 7/026; H04W 72/048; H04W 72/0426; H04W 72/0433; H04W 88/04

(57) ABSTRACT

A method and apparatus for obtaining information on a candidate cooperative device in a wireless communication system is provided. A base station receives information on a candidate source device from the candidate source device, receives information on a candidate cooperative device, discovered by the candidate source device, from the candidate source device, and determines whether the candidate cooperative device is served by the base station or not based on a database which includes information on a plurality of candidate source device served by the base station.

### BACKGROUND OF THE INVENTION

1. Field of the Invention

The present invention relates to wireless communications, and more particularly, to a method and apparatus for obtaining information on client cooperation in a wireless communication system.

2. Related Art

With the advent of a ubiquitous environment, there is a rapid increase in a demand for receiving a seamless service anytime anywhere by using equipments. In order to satisfy such a demand, a client cooperation technique may be introduced in a wireless communication system. The client cooperation technique refers to a technique by which a specific device helps transmission of another device. That is, one device may directly communicate with a base station (BS) or may indirectly communication with the BS by the aid of another device. A source device refers to a device which communicates with the BS through a connection with another device. A cooperation device refers to a relay entity which helps the source device to communicate with the BS.

The client cooperation technique has an effect of lower power consumption. In terms of a device, a path-loss can be decreased by the client cooperation technique, thereby being able to decrease transmit power. In terms of a network, total network power consumption can be decreased. In addition, the client cooperation technique has an effect of throughput enhancement. In terms of a device, a source device can use a good-quality link between a cooperation device and a BS and between BSs. In addition, an antenna extension gain can be obtained. In terms of the network, network capacity can be increased by using client clustering based on frequency reuse without an additional infrastructure.

The client cooperation technique can be more effectively used in a multi-radio access technology (RAT) device. The multi-RAT device refers to a device that can operate in a plurality of communication systems. For example, the multi-RAT device can operate both in institute of electrical and electronics engineers (IEEE) 802.16m and IEEE 802.11. To provide an easiness access to the BS anytime anywhere and to maintain effective performance, the multi-RAT device can use a multi-RAT client cooperation technique (i.e., improved tethering) in a heterogeneous network.

Various scenarios can be expected to implement a client cooperation technique. A serving base station (BS) of a source device may be identical to or different from a BS with which a source BS intends to communicate by using the client cooperation technique. Each device and BS may operate differently according to a scenario for implementing the client cooperation technique.

Accordingly, each device and BS need to know by which scenario the client cooperation technique is performed.

### SUMMARY OF THE INVENTION

The present invention provides a method and apparatus for obtaining information on client cooperation in a wireless communication system. The present invention also provides a method in which a base station obtains information on a candidate cooperative device which may be a cooperative device for performing a client cooperation technique. In particular, the present invention provides a method in which a base station obtains information on a candidate cooperative device, including an identifier of a serving base station which serves the candidate cooperative device.

In an aspect, a method for obtaining, by a base station, information on a candidate cooperative device in a wireless communication system is provided. The method includes receiving information on a candidate source device from the candidate source device, receiving information on a candidate cooperative device, discovered by the candidate source device, from the candidate source device, and determining whether the candidate cooperative device is served by the base station or not based on a database which includes information on a plurality of candidate source device served by the base station.

The information on the candidate cooperative device may include an identifier of a base station serving the candidate cooperative device.

The information on the candidate source device may be received during a network reentry procedure.

The information on the candidate source device may be received during a radio resource control (RRC) reestablishment procedure.

The information on the candidate source device may be a media access control (MAC) address or a peer identifier (ID) of the candidate source device.

The method may further include transmitting a request to share the information on the candidate cooperative device to a neighbor base station, if it is determined that the candidate cooperative device is not served by the base station.

The method may further include receiving an indication indicating whether the candidate cooperative device is served by the neighbor base station or not from the neighbor base station.

The method may further include sharing the information on the candidate cooperative device with a neighbor base station.

The method may further include determining by which neighbor base station the candidate cooperative device is served, if it is determined that the candidate cooperative device is not served by the base station.

The method may further include sharing the information on the candidate cooperative device with a controller.

The method may further include transmitting a request to share the information on the candidate cooperative device to the controller, if it is determined that the candidate cooperative device is not served by the base station.

The method may further include receiving an indication indicating by which neighbor base station the candidate cooperative device is served.

In another aspect, a method for obtaining, by a base station, information on a candidate cooperative device in a wireless communication system is provided. The method includes receiving information on a candidate source device from the candidate source device, transmitting the information on the candidate source device to a controller, and receiving an indication indicating by which neighbor base station the candidate cooperative device is served from the controller.

The information on the candidate source device may be transmitted through a non-stratum access (NAS) message.

Each device and base station can know by which scenario a client cooperation technique is performed.

### BRIEF DESCRIPTION OF THE DRAWINGS

FIG. 1 shows a wireless communication system.

FIG. 2 shows an example of a frame structure of IEEE 802.16m.

FIG. 3 shows an example of a frame structure of IEEE 802.11.

FIG. 4 shows an example of implementing a client cooperation technique.

FIG. 5 shows another example of implementing a client cooperation technique.

FIG. 6 shows an example of a scenario by which a client cooperation technique is performed.

FIG. 7 shows another example of a scenario for performing a client cooperation technique.

FIG. 8 shows an example of a method of determining a serving BS of a candidate cooperative device according to an embodiment of the present invention.

FIG. 9 shows another example of a method of determining a serving BS of a candidate cooperative device according to an embodiment of the present invention.

FIG. 10 shows another example of a method of determining a serving BS of a candidate cooperative device according to an embodiment of the present invention.

FIG. 11 shows another example of a method of determining a serving BS of a candidate cooperative device according to an embodiment of the present invention.

FIG. 12 shows another example of a method of determining a serving BS of a candidate cooperative device according to an embodiment of the present invention.

FIG. 13 shows another example of a method of determining a cooperative device of client cooperation according to an embodiment of the present invention.

FIG. 14 is a block diagram showing wireless communication system to implement an embodiment of the present invention.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11 (Wi-Fi), IEEE 802.16 (WiMAX), IEEE 802-20, or Evolved UTRA (E-UTRA). IEEE 802.16m is the evolution of IEEE 802.16e, and it provides a backward compatibility with an IEEE 802.16e-based system. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

IEEE 802.16m and IEEE 802.11 are chiefly described as an example in order to clarify the description, but the technical spirit of the present invention is not limited to IEEE 802.16m and IEEE 802.11.

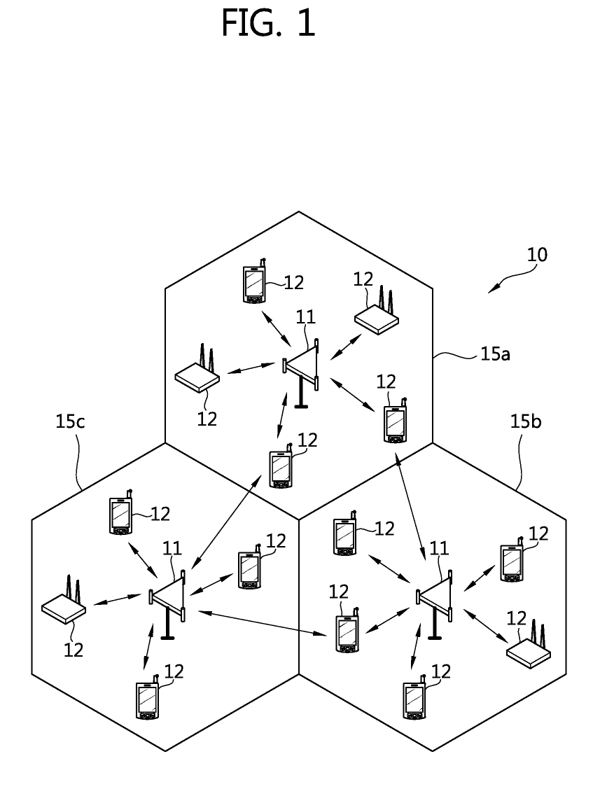

FIG. 1 shows a wireless communication system.

Referring to FIG. 1, the wireless communication system 10 includes one or more base stations (BSs) 11. The BSs 11 provide communication services to respective geographical areas (in general called ‘cells’) 15a, 15b, and 15c. Each of the cells can be divided into a number of areas (called ‘sectors’). A user equipment (UE) 12 can be fixed or mobile and may be referred to as another terminology, such as a mobile station (MS), a mobile terminal (MT), a user terminal (UT), a subscriber station (SS), a wireless device, a personal digital assistant (PDA), a wireless modem, or a handheld device. In general, the BS 11 refers to a fixed station that communicates with the UEs 12, and it may be referred to as another terminology, such as an evolved-NodeB (eNB), a base transceiver system (BTS), or an access point.

The UE generally belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

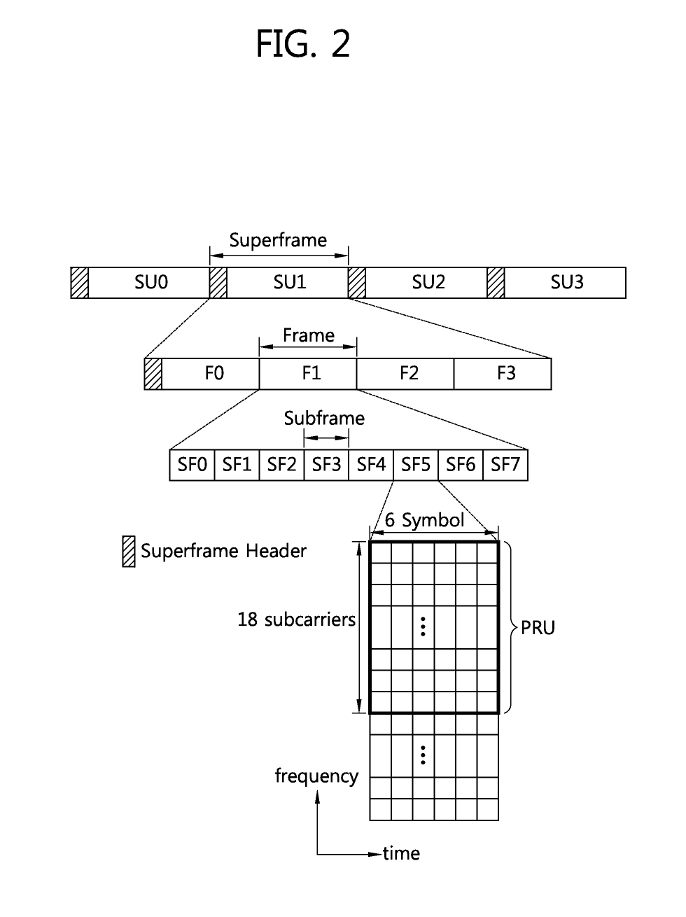

FIG. 2 shows an example of a frame structure of IEEE 802.16m.

Referring to FIG. 2, a superframe (SF) includes a superframe header (SFH) and four frames F0, F1, F2, and F3. Each frame may have the same length in the SF. Although it is shown that each SF has a length of 20 milliseconds (ms) and each frame has a length of 5 ms, the present invention is not limited thereto. A length of the SF, the number of frames included in the SF, the number of SFs included in the frame, or the like can change variously. The number of SFs included in the frame may change variously according to a channel bandwidth and a cyclic prefix (CP) length.

One frame includes 8 subframes SF0, SF1, SF2, SF3, SF4, SF5, SF6, and SF7. Each subframe can be used for uplink or downlink transmission. One subframe includes a plurality of orthogonal frequency division multiplexing (OFDM) symbols in a time domain, and includes a plurality of subcarriers in a frequency domain. An OFDM symbol is for representing one symbol period, and can be referred to as other terminologies such as an OFDM symbol, an SC-FDMA symbol, etc., according to a multiple access scheme. The subframe can consist of 5, 6, 7, or 9 OFDMA symbols. However, this is for exemplary purposes only, and thus the number of OFDMA symbols included in the subframe is not limited thereto. The number of OFDMA symbols included in the subframe may change variously according to a channel bandwidth and a CP length. A subframe type may be defined according to the number of OFDMA symbols included in the subframe. For example, it can be defined such that a type-1 subframe includes 6 OFDMA symbols, a type-2 subframe includes 7 OFDMA symbols, a type-3 subframe includes 5 OFDMA symbols, and a type-4 subframe includes 9 OFDMA symbols. One frame may include subframes each having the same type. Alternatively, one frame may include subframes each having a different type. That is, the number of OFDMA symbols included in each subframe may be identical or different in one frame. Alternatively, the number of OFDMA symbols included in at least one subframe of one frame may be different from the number of OFDMA symbols of the remaining subframes of the frame.

Time division duplex (TDD) or frequency division duplex (FDD) may be applied to the frame. In the TDD, each subframe is used in uplink or downlink transmission at the same frequency and at a different time. That is, subframes included in a TDD frame are divided into an uplink subframe and a downlink subframe in the time domain. A switching point refers to a point where a transmission direction is changed from an uplink region to a downlink region or from a downlink region to an uplink region. In the TDD, the number of the switching points in each frame may be two. In the FDD, each subframe is used in uplink or downlink transmission at the same time and at a different frequency. That is, subframes included in an FDD frame are divided into an uplink subframe and a downlink subframe in the frequency domain. Uplink transmission and downlink transmission occupy different frequency bands and can be simultaneously performed.

One OFDMA symbol includes a plurality of subcarriers. The number of subcarriers is determined by a fast Fourier transform (FFT) size. The subcarrier can be classified into a data subcarrier for data transmission, a pilot subcarrier for various estimations, and a null subcarrier for a guard band and a direct current (DC) carrier. The OFDMA symbol is characterized by parameters BW, N_{used}, n, G, etc. The parameter BW denotes a nominal channel bandwidth. The parameter N_{used} denotes the number of used subcarriers (including the DC subcarrier). The parameter n denotes a sampling factor. The parameter n is combined with the parameters BW and N_{used} to determine a subcarrier spacing and a useful symbol time. The parameter G denotes a ratio of a cyclic prefix (CP) time and a useful time.

Table 1 below shows an orthogonal frequency division multiple access (OFDMA) parameter.

TABLE 1

| Channel bandwidth, BW(MHz) | | | 5 | 7 | 8.75 | 10 | 20 |
|---|---|---|---|---|---|---|---|
| Sampling factor, n | | | 28/25 | 8/7 | 8/7 | 28/25 | 28/25 |
| Sampling frequency, Fₛ(MHz) | | | 5.6 | 8 | 10 | 11.2 | 22.4 |
| FFT size, N_{FFT} | | | 512 | 1024 | 1024 | 1024 | 2048 |
| Subcarrier spacing, Δf(kHz) | | | 10.94 | 7.81 | 9.77 | 10.94 | 10.94 |
| Useful symbol time T_{b}(μs) | | | 91.4 | 128 | 102.4 | 91.4 | 91.4 |
| G = ⅛ | Symbol time, Tₛ(μs) | | 102.857 | 144 | 115.2 | 102.857 | 102.857 |
| | FDD | Number of | 48 | 34 | 43 | 48 | 48 |
| | | OFDMA symbols | | | | | |
| | | per 5 ms frame | | | | | |
| | | Idle time(μs) | 62.857 | 104 | 46.40 | 62.857 | 62.857 |
| | TDD | Number of | 47 | 33 | 42 | 47 | 47 |
| | | OFDMA symbols | | | | | |
| | | per 5 ms frame | | | | | |
| | | TTG + RTG(μs) | 165.714 | 248 | 161.6 | 165.714 | 165.714 |
| G = 1/16 | Symbol time, Tₛ(μs) | | 97.143 | 136 | 108.8 | 97.143 | 97.143 |
| | FDD | Number of | 51 | 36 | 45 | 51 | 51 |
| | | OFDMA symbols | | | | | |
| | | per 5 ms frame | | | | | |
| | | Idle time(μs) | 45.71 | 104 | 104 | 45.71 | 45.71 |
| | TDD | Number of | 50 | 35 | 44 | 50 | 50 |
| | | OFDMA symbols | | | | | |
| | | per 5 ms frame | | | | | |
| | | TTG + RTG(μs) | 142.853 | 240 | 212.8 | 142.853 | 142.853 |
| G = ¼ | Symbol time, Tₛ(μs) | | 114.286 | 160 | 128 | 114.286 | 114.286 |
| | FDD | Number of | 43 | 31 | 39 | 43 | 43 |
| | | OFDMA symbols | | | | | |
| | | per 5 ms frame | | | | | |
| | | Idle time(μs) | 85.694 | 40 | 8 | 85.694 | 85.694 |
| | TDD | Number of | 42 | 30 | 38 | 42 | 42 |
| | | OFDMA symbols | | | | | |
| | | per 5 ms frame | | | | | |
| | | TTG + RTG(μs) | 199.98 | 200 | 136 | 199.98 | 199.98 |

| | | | | | | |
|---|---|---|---|---|---|---|
| Number of Guard | Left | 40 | 80 | 80 | 80 | 160 |
| subcarriers | Right | 39 | 79 | 79 | 79 | 159 |

| | | | | | |
|---|---|---|---|---|---|
| Number of used subcarriers | 433 | 865 | 865 | 865 | 1729 |
| Number of PRU in type-1 subframe | 24 | 48 | 48 | 48 | 96 |

In Table 1, N_{FFT} denotes a smallest power of 2 greater than N_{used}. A sampling factor is defined as Fₛ=floor(n·BW/8000)×8000. A subcarrier spacing is defined as Δf=Fₛ/NFFT. A useful symbol time is defined as T_{b}=1/Δf. A CP time is defined as T_{g}=G·T_{b}. An OFDMA symbol time is defined as Tₛ=T_{b}+T_{g}. A sampling time is defined as T_{b}/N_{FFT}.

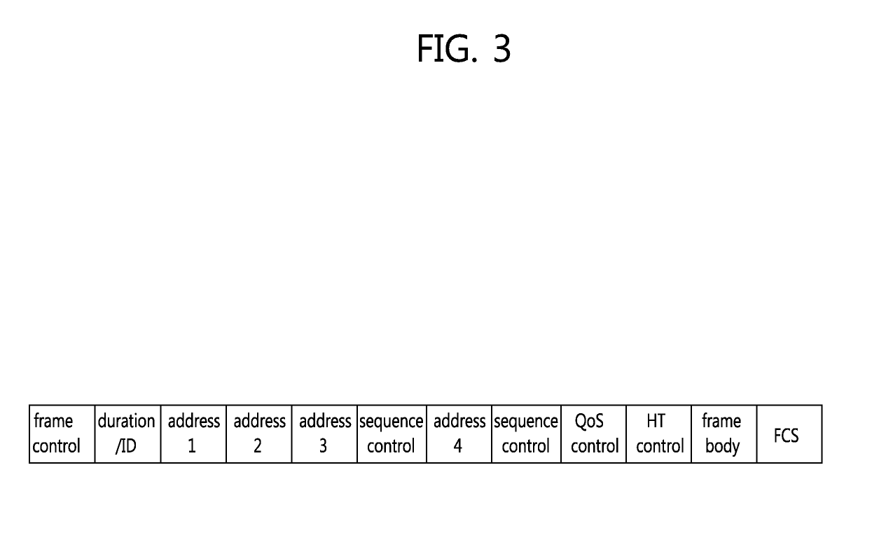

FIG. 3 shows an example of a frame structure of IEEE 802.11.

A frame of IEEE 802.11 includes a set of fields in a fixed order. Referring to FIG. 3, the frame of IEEE 802.11 includes a frame control field, a duration/ID field, an address 1 field, an address 2 field, an address 3 field, a sequence control field, an address 4 field, a quality of service (QoS) control field, an HT control field, a frame body field, and a frame check sequence (FCS) field. Among the fields listed above, the frame control field, the duration/ID field, the address 1 field, and the FCS field constitute a minimum IEEE 802.11 frame format, and may be included in all IEEE 802.11 frames. The address 2 field, the address 3 field, the sequence control field, the address 4 field, the QoS control field, the HT control field, and the frame body field may be included only in a specific frame type.

The frame control field may include various subfields. The duration/ID field may be 16 bits in length. The address field may include a basic service set identifier (BSSID), a source address (SA), a destination address (DA), a transmitting STA address (TA), and a receiving STA address (RA). In the address field, different fields may be used for other purposes according to a frame type. The sequence control field can be used when fragments are reassembled or when an overlapping frame is discarded. The sequence control field may be 16 bits, and may include two subfields indicating a sequence number and a fragment number. The FCS field can be used to check an error of a frame received by a station. The FCS field may be a 32-bit field including a 32-bit cyclic redundancy check (CRC). An FCS can be calculated across the frame body field and all fields of a media access control (MAC) header.

The frame body field may include information specified for an individual frame type and subtype. That is, the frame body field carries high-level data from one station to another station. The frame body field can also be called a data field. The frame body field can be variously changed in length. A minimum length of the frame body field may be zero octet. A maximum length of the frame body field may be determined by a total sum of a maximum length of a MAC service data unit (MSDU), a length of a mesh control field, and an overhead for encryption or a total sum of a maximum length of an aggregated MSDU (A-MSDU) and an overhead for encryption. The data frame includes high-level protocol data of the frame body field. The data frame may always include the frame control field, the duration/ID field, the address 1 field, the address 2 field, the address 3 field, the sequence control field, the frame body field, and the FCS field. A presence of an address 4 field may be determined by a configuration of a ‘To DS’ subfield and a ‘From DS’ subfield in the frame control field. Another data frame type can be categorized according to a function.

A management frame may always include the frame control field, the duration/ID field, the address 1 field, the address 2 field, the address 3 field, the sequence control field, the frame body field, and the FCS field. Data included in the frame body field generally uses a fixed-length field called a fixed field and a variable-length field called an information element. The information element is a variable-length data unit.

The management frame can be used for various purposes according to a subtype. That is, a frame body field of a different subtype includes different information. A beacon frame reports an existence of a network, and takes an important role of network maintenance. The beacon frame corresponds to a parameter which allows a mobile station to participate in the network. In addition, the beacon frame is periodically transmitted so that the mobile station can scan and recognize the network. A probe request frame is used to scan an IEEE 802.11 network in which the mobile station exists. A probe response frame is a response for the probe request frame. An authentication request is used so that the mobile station requests an access point to perform authentication. An authentication response frame is a response for the authentication request frame. A deauthentication frame is used to finish an authentication relation. An association request frame is transmitted so that the mobile station participates in the network when the mobile station recognizes the compatible network and is authenticated. An association response frame is a response for the association request frame. A deassociation frame is used to finish an association relation.

Three states may exist according to an authentication and association procedure in IEEE 802.11. Table 2 below shows the three states of IEEE 802.11.

TABLE 2

| | Authentication | Association |
|---|---|---|
| State 1 | X | X |
| State 2 | ◯ | X |
| State 3 | ◯ | ◯ |

To transmit a data frame, a device must perform the authentication and association procedure with respect to a network. In Table 2, a procedure of transitioning from the state 1 to the state 2 can be called the authentication procedure. The authentication procedure can be performed in such a manner that one device acquires information of a different device and authenticates the different device. The information of the different device can be acquired by using two methods, i.e., a passive scanning method for acquiring information of a different node by receiving a beacon frame and an active scanning method for acquiring the information of the different device by transmitting a probe request message and receiving a probe response message received in response thereto. The authentication procedure can be complete by exchanging an authentication request frame and an authentication response frame.

In Table 2, a procedure of transitioning from the state 2 to the state 3 can be called the association procedure. The association procedure can be complete when two devices exchange the association request frame and the association response frame upon completion of the authentication procedure. An association ID can be allocated by the association procedure.

Hereinafter, a client cooperation technique will be described. Hereinafter, a source device refers to a device which communicates with the BS through a connection with another device. A cooperation device refers to a relay entity which helps the source device to communicate with the BS.

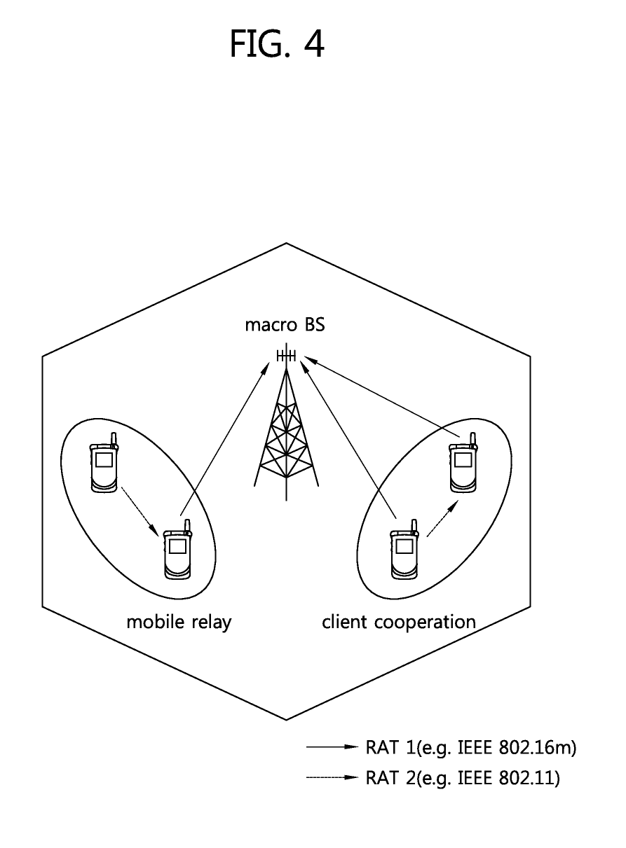

FIG. 4 shows an example of implementing a client cooperation technique.

Referring to FIG. 4, in the client cooperation technique, a source device can directly communicate with a macro BS, or can communicate with the macro BS via a cooperation device. The cooperation device may directly communicate with the macro BS, or can help communication of the source device. This is different from a mobile relay in a sense that the source device can directly communicate with the macro BS. In this case, each device and the macro BS can communicate by using a first radio access technology (RAT), and the source device and the cooperation device can communicate by using a second RAT. The first RAT may be a radio technology such as IEEE 802.16, IEEE 802.16m or IEEE 802.20, etc. Alternatively, the first RAT may be a radio technology such as E-UTRA, 3GPP LTE or 3GPP LTE-A, etc. The second RAT may be IEEE 802.11.

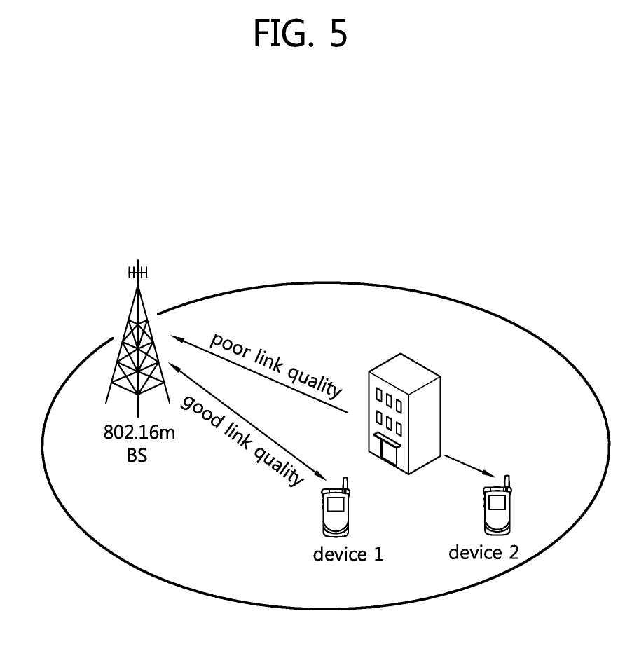

FIG. 5 shows another example of implementing a client cooperation technique.

The client cooperation technique can be more effectively used in a multi-RAT device. The multi-RAT device refers to a device that can operate in a plurality of communication systems. For example, the multi-RAT device can operate both in IEEE 802.16m and IEEE 802.11. When the multi-RAT device uses the client cooperation technique, the multi-RAT device can communicate with an IEEE 802.16m BS by using a plurality of RATs. For example, as shown in FIG. 5, if channel quality is poor between a second device and a BS or if the second device located in a shadow area cannot receive a signal from the BS, the first device can be used as a cooperation device to communicate with the BS. In this case, each device and the BS can communicate by using the first RAT, and the source device and the cooperation device can communicate by using the second RAT. The first RAT may be a radio technique such as IEEE 802.16, IEEE 802.16m, IEEE 802.20, E-UTRA, 3GPP LTE or 3GPP LTE-A, etc. The second RAT may be IEEE 802.11.

A client cooperation technique can be performed according to various scenarios.

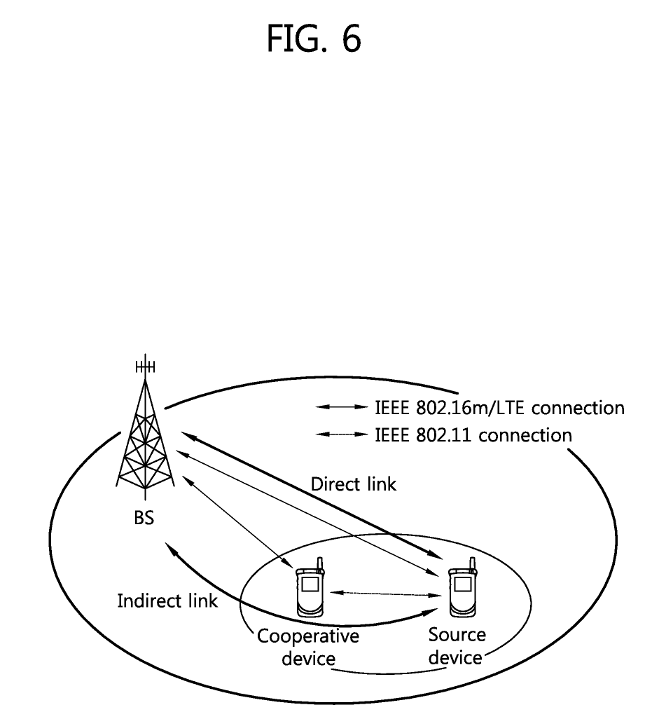

FIG. 6 shows an example of a scenario by which a client cooperation technique is performed.

Referring to FIG. 6, a source device and a macro base station (BS) are connected through a direct link, and are connected through an indirect link via a cooperative device. Each device and BS may be connected through IEEE 802.16m or 3GPP LTE/LTE-A, and the source device and the cooperative device may be connected through IEEE 802.11. The macro BS connected to the source device is a serving BS which serves the source device. That is, in the scenario of FIG. 6, the serving BS of the source device is the same as a BS with which the source device intends to communicate via the cooperative device.

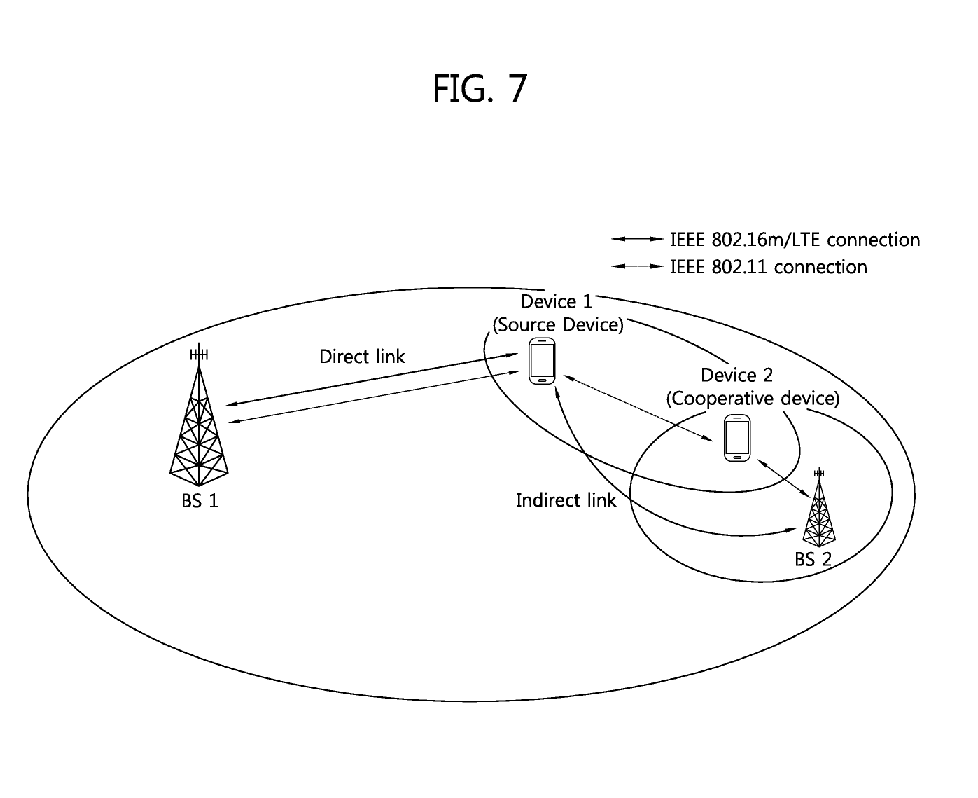

FIG. 7 shows another example of a scenario for performing a client cooperation technique.

Referring to FIG. 7, a source device (i.e., a device 1) is connected to a BS 1 through a direct link. In addition, the source device is connected to a BS 2 through an indirect link via a cooperative device (i.e., a device 2). Each device and BS may be connected through IEEE 802.16m or 3GPP LTE/LTE-A, and the source device and the cooperative device may be connected through IEEE 802.11. A serving BS which serves the source device is the BS 1, and a BS with which the source device intends to communicate via the cooperative device is the BS 2. That is, in the scenario of FIG. 7, the serving BS of the source device is different from the BS with which the source device intends to communicate via the cooperative device. This scenario may occur when the source device served by the BS 1 is neighboring to the BS 2. If the source device neighboring to the BS 2 intends to communicate with the BS 1 which serves the source device through a direct link, the source device may cause a severe interference to other devices located in the coverage of the BS 2 due to high transmit power. Therefore, in order to reduce the interference caused by the source device, a network can allow the source device to communicate with the BS 2 through an indirect link by using the client cooperation technique. The BS 2 can deliver data, which is received from the source device, to the BS 1 through a backbone network or the like.

When the network intends to perform the client cooperation technique in a situation where the network knows a presence of a certain device irrespective of a state of the device, each device and BS may perform different operations and procedures according to the scenario by which the client cooperation technique is performed. Therefore, each device and BS need to know by which scenario the client cooperation technique is performed. For this, each device and BS need to recognize a serving BS of a candidate of a cooperative device capable of performing the client cooperation technique.

Hereinafter, a method in which each device and BS determine a serving BS of a candidate of a cooperative device capable of performing a client cooperation technique will be described according to an embodiment of the present invention. In the following description, a device for performing a discovery operation to perform the client cooperation technique is called a candidate source device, and the candidate of the cooperative device capable of performing the client cooperation technique is called a candidate cooperative device. In addition, it is assumed hereinafter that the number of serving BSs for the device is greater than or equal to 1.

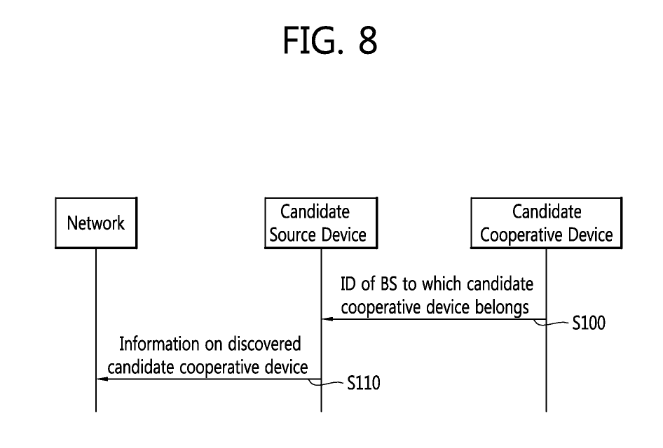

FIG. 8 shows an example of a method of determining a serving BS of a candidate cooperative device according to an embodiment of the present invention.

Referring to FIG. 8, the candidate cooperative device transmits an identifier of a BS to which the candidate cooperative device belongs in step S100. The identifier of the BS may be a BS identifier (ID) or a cell ID. The identifier of the BS may be transmitted by being appended to a parameter such as the existing beacon message, probe message, authentication message, association message, etc., or may be transmitted by using a newly defined message.

In step S110, the candidate source device performs a discovery operation, and delivers information on a discovered candidate cooperative device to a network. The information on the discovered candidate cooperative device may include the identifier of the BS to which the candidate cooperative device belongs. The candidate source device may deliver to the network only the information on the candidate cooperative device of which a serving BS is different from a serving BS of the candidate source device. That is, if all of serving BSs of discovered candidate cooperative devices are the same as the serving BS of the candidate source device, the candidate source device may not deliver the information on the discovered candidate cooperative device to the network. In this manner, the candidate source device and the serving BS can determine a serving BS of each candidate cooperative device.

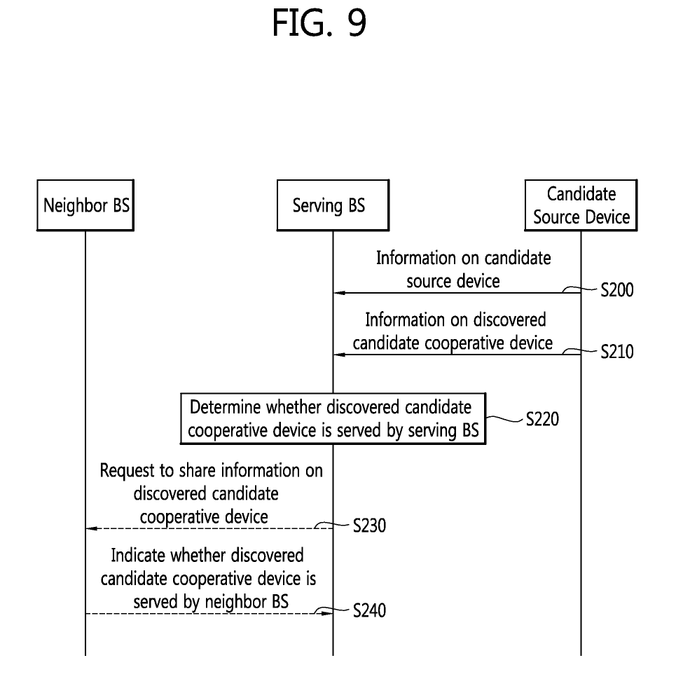

FIG. 9 shows another example of a method of determining a serving BS of a candidate cooperative device according to an embodiment of the present invention.

Referring to FIG. 9, a candidate source device can transmit its information to perform client cooperation in a network entry or re-entry procedure in step S200. Information on all devices belonging to the network is obtained in this manner, and can be managed by a network by using a first database. The network entry or re-entry procedure of the candidate source device may be either a network re-entry procedure in IEEE 802.16m or a radio resource control (RRC) reestablishment procedure in 3GPP LTE/LTE-A. The candidate source device's information transmitted by the candidate source device may be a device identifier of the candidate source device, and for example, may be either a MAC address or a peer ID in IEEE 802.11.

Meanwhile, an entity for managing the first database may be a serving BS, or may be either a mobility management entity (MME) or a serving gateway (S-GW). Although it is assumed in the embodiment of FIG. 9 that the candidate source device transmits its information to the serving BS, this is for exemplary purposes only. The serving BS may manage the first database directly without an aid of other elements, or may transmit the received information on the candidate source device to the MME or the S-GW. In this case, the first database may be managed by the MME or the S-GW.

In step S210, the candidate source device discovers the candidate cooperative device, and delivers information on the discovered candidate cooperative device to the serving BS. In step S220, the serving BS discovers an identifier of each candidate cooperative device, transmitted by the candidate source device, from the first database of the serving BS and determines whether the candidate cooperative device is served by the serving BS. If the serving BS is capable of discovering the information on the discovered candidate cooperative device from its first database, the serving BS may determine that the candidate cooperative device is served by the serving BS.

If the serving BS is not capable of discovering the information on the discovered candidate cooperative device from its first database or if each device is designed to be able to have two or more serving BSs, in step S230, the serving BS may request neighbor BSs to share the information on the candidate cooperative device. In step S240, the neighbor BSs may discover the information on the candidate cooperative device from their first databases, and may report to the serving BS whether the candidate cooperative device is served by the neighbor BSs. If the neighbor BS is capable of discovering the information on the discovered candidate cooperative device from the first database, the neighbor BS may determine that the candidate cooperative device is served by the neighbor BS.

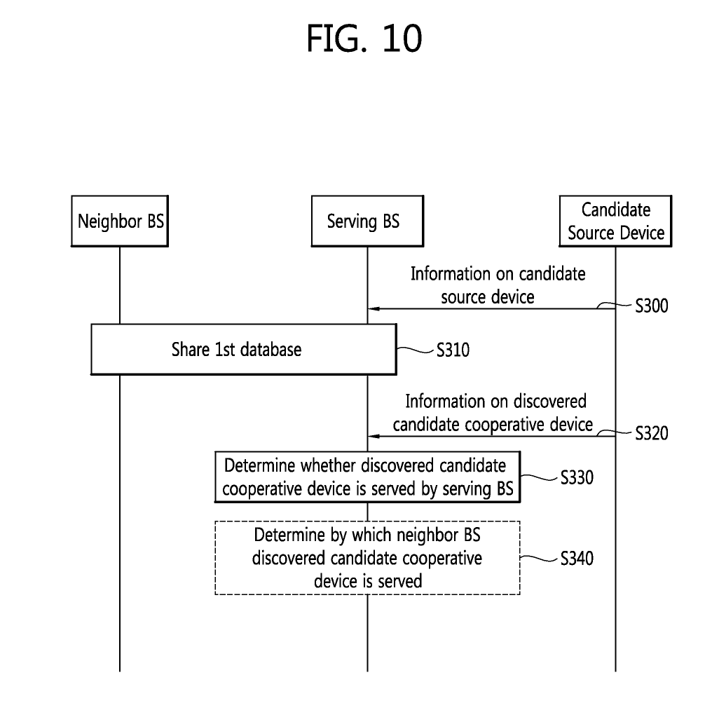

FIG. 10 shows another example of a method of determining a serving BS of a candidate cooperative device according to an embodiment of the present invention.

Referring to FIG. 10, a candidate source device can transmit its information to perform client cooperation in a network entry or re-entry procedure in step S300. Information on all devices belonging to the network is obtained in this manner, and can be managed by a network by using a first database. The network entry or re-entry procedure of the candidate source device may be either a network re-entry procedure in IEEE 802.16m or an RRC reestablishment procedure in 3GPP LTE/LTE-A. The candidate source device's information transmitted by the candidate source device may be a device identifier of the candidate source device, and for example, may be either a MAC address or a peer ID in IEEE 802.11. In step S310, the serving BS and a neighbor BS share their first databases.

In step S320, the candidate source device discovers the candidate cooperative device, and delivers information on the discovered candidate cooperative device to the serving BS. In step S330, the serving BS discovers an identifier of each candidate cooperative device, transmitted by the candidate source device, from the first database of the serving BS and determines whether the candidate cooperative device is served by the serving BS. If the serving BS is capable of discovering the information on the discovered candidate cooperative device from its first database, the serving BS may determine that the candidate cooperative device is served by the serving BS.

If the serving BS is not capable of discovering the information on the discovered candidate cooperative device from its first database or if each device is designed to be able to have two or more serving BSs, in step S340, the serving BS can discover an identifier of each candidate cooperative device, transmitted by the candidate source device, from the first database of the neighbor BS, and can determine by which BS the candidate cooperative device is served.

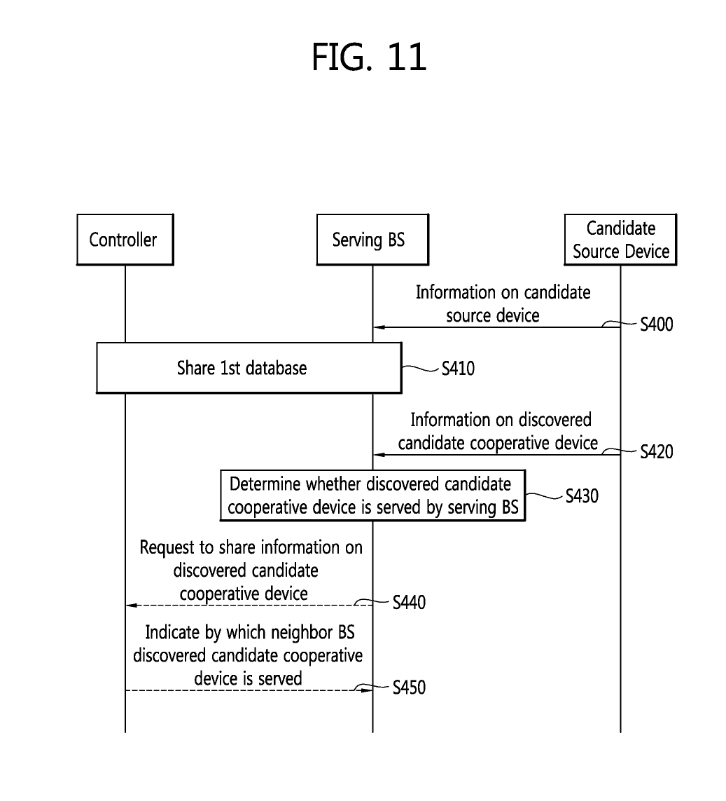

FIG. 11 shows another example of a method of determining a serving BS of a candidate cooperative device according to an embodiment of the present invention.

Referring to FIG. 11, a candidate source device can transmit its information to perform client cooperation in a network entry or re-entry procedure in step S400. Information on all devices belonging to the network is obtained in this manner, and can be managed by a network by using a first database. The network entry or re-entry procedure of the candidate source device may be either a network re-entry procedure in IEEE 802.16m or an RRC reestablishment procedure in 3GPP LTE/LTE-A. The candidate source device's information transmitted by the candidate source device may be a device identifier of the candidate source device, and for example, may be either a MAC address or a peer ID in IEEE 802.11. In step S410, BSs share their first databases via a controller. The controller may be either a MME or an S-GW.

In step S420, the candidate source device discovers the candidate cooperative device, and delivers information on the discovered candidate cooperative device to the serving BS. In step S430, the serving BS discovers an identifier of each candidate cooperative device, transmitted by the candidate source device, from the first database of the serving BS and determines whether the candidate cooperative device is served by the serving BS. If the serving BS is capable of discovering the information on the discovered candidate cooperative device from its first database, the serving BS may determine that the candidate cooperative device is served by the serving BS.

If the serving BS is not capable of discovering the information on the discovered candidate cooperative device from its first database or if each device is designed to be able to have two or more serving BSs, in step S440, the serving BS may request the controller to share the information on the candidate cooperative device. In step S450, the controller may discover the information on the candidate cooperative device from a first database of a neighbor BS, and may transmit to the serving BS an indication indicating by which BS the candidate cooperative device is served.

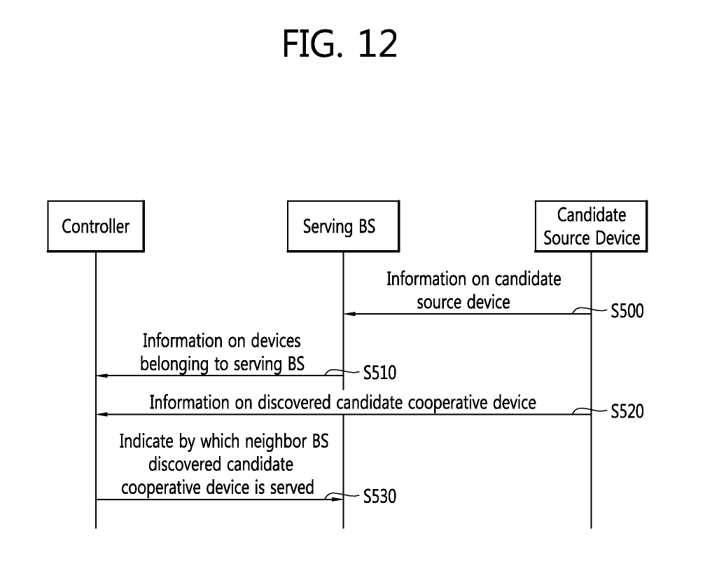

FIG. 12 shows another example of a method of determining a serving BS of a candidate cooperative device according to an embodiment of the present invention.

Referring to FIG. 12, a candidate source device can transmit its information to perform client cooperation in a network entry or re-entry procedure in step S500. The network entry or re-entry procedure of the candidate source device may be either a network re-entry procedure in IEEE 802.16m or an RRC reestablishment procedure in 3GPP LTE/LTE-A. The candidate source device's information transmitted by the candidate source device may be a device identifier of the candidate source device, and for example, may be either a MAC address or a peer ID in IEEE 802.11.

In step S510, the serving BS delivers information on all devices belonging to the serving BS to a controller. The serving BS can deliver the information on all devices belonging to the serving BS to the controller by using a non-stratum access (NAS) message or the like. The controller manages information on devices, delivered from all BSs, by using a second database.

In step S520, the candidate source device discovers the candidate cooperative device, and delivers information on the discovered candidate cooperative device to the controller. In step S530, the controller discovers an identifier of each candidate cooperative device, transmitted by the candidate source device, from the second database and transmits to the serving BS an indication indicating by which BS the candidate cooperative device is served.

Hereinafter, a method of determining a cooperative device for performing client cooperation will be described.

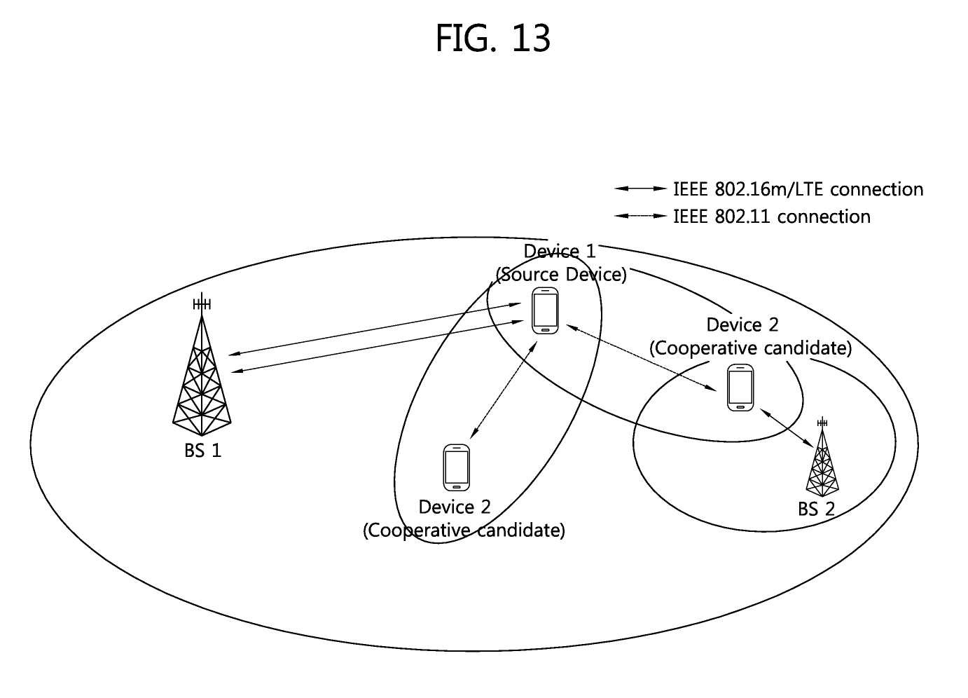

FIG. 13 shows another example of a method of determining a cooperative device of client cooperation according to an embodiment of the present invention.

Referring to FIG. 13, a device 1 and a device 3 are connected to a BS 1 through a direct link, and a device 2 is connected to a BS 2 through a direct link. That is, the device 1 and the device 3 are served by the BS 1, and the device 2 is served by the BS 2. When the device 1 intends to operate as a source device of client cooperation, a network may determine which device will be used as a cooperative device for the source device among one or more candidate cooperative devices (i.e., the device 2 and the device 3). In this case, the network may consider obtained information on each candidate cooperative device. The information on each cooperative device may include information on a BS which serves each candidate cooperative device. By considering the information on each candidate cooperative device, the network can determine a certain BS via which the source device performs communication effectively in a system aspect. That is, the network may determine to use a candidate cooperative device belonging to a BS determined to be more effective as the cooperative device for the source device.

The network may request the candidate cooperative device determined to be used as the cooperative device for the source device to operate as the cooperative device. That is, the network may obtain an acceptance of the determined candidate cooperative device. The network may obtain the acceptance of the determined candidate cooperative device by transmitting a request message including information on the source device to the candidate cooperative device. The candidate cooperative device may transmit to the network a response for the request. If the candidate cooperative device accepts the request, the network may report information on the candidate cooperative device to the source device. If the candidate cooperative device denies the request, the network may perform a procedure of obtaining an acceptance of a second best candidate cooperative device.

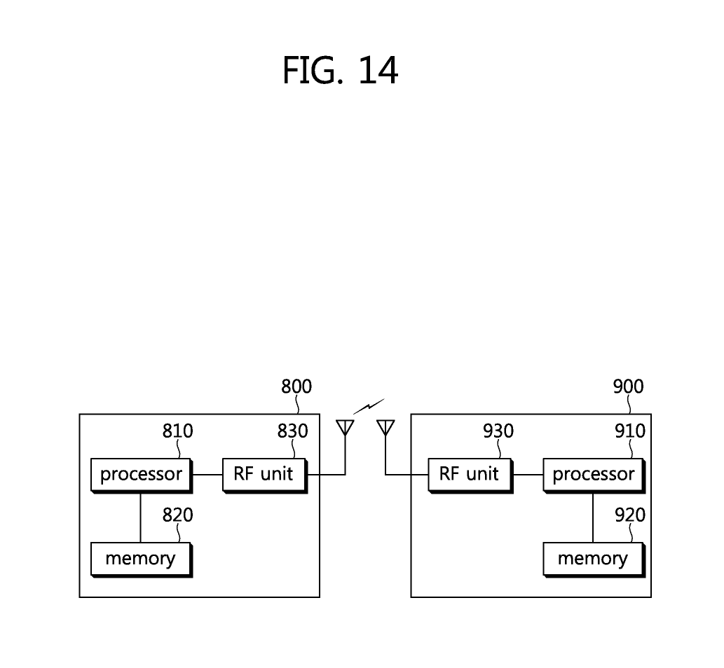

FIG. 14 is a block diagram showing wireless communication system to implement an embodiment of the present invention.

A BS 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A device 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for obtaining, by a base station, information on a candidate cooperative device in a wireless communication system, the method comprising:
receiving information on a candidate source device from the candidate source device;
receiving information on a candidate cooperative device, discovered by the candidate source device, from the candidate source device; and
determining whether the candidate cooperative device is served by the base station or not based on a database which includes information on a plurality of candidate source device served by the base station.

2. The method of claim 1, wherein the information on the candidate cooperative device includes an identifier of a base station serving the candidate cooperative device.

3. The method of claim 1, wherein the information on the candidate source device is received during a network reentry procedure.

4. The method of claim 1, wherein the information on the candidate source device is received during a radio resource control (RRC) establishment procedure.

5. The method of claim 1, wherein the information on the candidate source device is a media access control (MAC) address or a peer identifier (ID) of the candidate source device.

6. The method of claim 1, if it is determined that the candidate cooperative device is not served by the base station, further comprising transmitting a request to share the information on the candidate cooperative device to a neighbor base station.

7. The method of claim 6, further comprising receiving an indication indicating whether the candidate cooperative device is served by the neighbor base station or not from the neighbor base station.

8. The method of claim 1, further comprising sharing the information on the candidate cooperative device with a neighbor base station.

9. The method of claim 8, if it is determined that the candidate cooperative device is not served by the base station, further comprising determining by which neighbor base station the candidate cooperative device is served.

10. The method of claim 1, further comprising sharing the information on the candidate cooperative device with a controller.

11. The method of claim 10, if it is determined that the candidate cooperative device is not served by the base station, further comprising transmitting a request to share the information on the candidate cooperative device to the controller.

12. The method of claim 11, further comprising receiving an indication indicating by which neighbor base station the candidate cooperative device is served.

13. A method for obtaining, by a base station, information on a candidate cooperative device in a wireless communication system, the method comprising:
receiving information on a candidate source device from the candidate source device;
transmitting the information on the candidate source device to a controller; and
receiving an indication indicating by which neighbor base station the candidate cooperative device is served from the controller.

14. The method of claim 13, wherein the information on the candidate source device is transmitted through a non-stratum access (NAS) message.

15. The method of claim 13, wherein the information on the candidate source device is a media access control (MAC) address or a peer identifier (ID) of the candidate source device.
